(19) United States
(12) Patent Application Publication
(10) Pub. No.: US 2022/0402775 A1
(43) Pub. Date: Dec. 22, 2022

(54) Water Clip

(71) Applicant: Fliskousa LLC, Brooklyn, NY (US)

(72) Inventor: David Templer, Brooklyn, NY (US)

(73) Assignee: Fliskousa LLC, Brooklyn, NY (US)

(21) Appl. No.: 17/354,808

(22) Filed: Jun. 22, 2021

(51) Int. Cl. C02F 1/00; C02F 1/28; C02F 1/42; B01D 35/34

(52) U.S. Cl. CPC C02F 1/002; C02F 1/283; C02F 1/42; B01D 35/34; C02F 2307/02; C02F 2201/004; B01D 2201/40; B01D 2201/347

(57) ABSTRACT

The present invention discloses a filtering apparatus for filtering liquid and dispensing the filtered liquid into a bottle separate from the filtering apparatus. The filtering apparatus includes an elongated housing having an interior for holding liquid. The elongated housing includes an opening at one end and a ceiling at another end. The opening encompasses projections extending towards the center of the elongated housing. The filtering apparatus includes a filter configured for insertion and removal from the elongated housing. The elongated housing receives the filter at the interior through the opening. The elongated housing receives a bottle at the opening and the projections hold the bottle at the opening while preventing further entry of the bottle into the interior of the elongated housing. The interior holds liquid and allows the liquid to flow down through the filter. The filter filters the liquid as it flows through. The filtered water enters the bottle for subsequent use, storage or transport.

### FIELD OF THE INVENTION

The present invention generally relates to containers with filters. More specifically, the present invention relates to a filtering apparatus for filtering liquid and dispensing the filtered liquid into a bottle separate from the filtering apparatus for subsequent use, storage or transport.

### BACKGROUND OF THE INVENTION

It is known that water is vital and beneficial to all life. Water provides necessary hydration to humans as the human body uses water in all of its cells, organs, and tissues to help regulate temperature and maintain other bodily functions. Water ideally should be clear with no odor or taste for safe drinking.

Water can get tainted with contaminants in a variety of ways such as storm water and pesticide runoff, industrial waste, acid rain, and the water treatment process itself. Even groundwater can get exposed to pathogen contaminants that may produce disease in humans. Unhealthy levels of contaminants in water interferes with water's healthy role, reduces the ability of the body to function properly, and can even cause death when extreme amounts are present. Therefore, water filtration has become common in homes, offices, and other places to produce healthier and better tasting water.

It has long been recognized that the high costs and inconvenience of accessing filtered water is a problem. Particularly, there has been a long felt need for a compact and convenient portable filtration device for making water safe for drinking.

Several attempts have been made in the past to provide portable bottles with filters that are easy to carry and use. One such example is disclosed in a U.S. Pat. No. 9,988,177 entitled “Bottle with filter and infusion base” (the “'177 Patent”). The '177 Patent discloses a bottle assembly having a cap assembly, a bottle body, a base assembly and a filter assembly. The cap assembly includes a straw. The bottle body is removably connectable to the cap assembly. The base assembly is removably connectable to the bottle body. The filter assembly is connectable to the bottle body, and the filter assembly includes an aperture configured for passage of a portion of the straw. The aperture includes a mechanism that is closable when the portion of the straw is not in the aperture. A method of using a bottle includes removing the cap assembly from an upper opening of the bottle body and introducing fluid into the upper opening of the bottle body and through a filter assembly, the filter assembly includes an aperture configured for passage of a portion of the straw. The method also includes closing the aperture.

Another example is disclosed in a U.S. Pat. No. 10,160,661 entitled “Portable, dual-orifice filtered water dispenser” (the “'661 Patent”). The '661 Patent discloses a portable water-filtering and storage dispenser having twin orifices at the top and bottom, the top orifice is for dispensing water to a user for consumption, the bottom orifice is for receiving water for filtration and storage. Water received via the bottom orifice is filtered by a dome filter and keyway insert. Both orifices are sealable with detachable caps for threadably mating with the body of the dispenser.

Although the above-discussed disclosures disclose portable bottles with filters, they have several limitations. For instance, the bottle integrates the filtering device. As such, the same bottle is used for filtering and storing water. This may lead to a situation where the contaminants filtered at the filter enter the filtered water and contaminate the water. Further, once the filter reaches its life, then the entire bottle needs to be discarded. This reduces the overall life of the bottle.

Therefore, there is a need for a filtering apparatus for filtering liquid and dispensing the filtered liquid into a bottle separate from the filtering apparatus for subsequent use, storage or transport.

### BRIEF SUMMARY OF THE INVENTION

It is an object of the present invention to provide a filtering apparatus and avoid the drawbacks of known bottles with filters.

It is another object of the present invention to provide a filtering apparatus for filtering liquid and dispensing the filtered liquid into a bottle separate from the filtering apparatus for subsequent use, storage or transport.

It is another object of the present invention to provide a filtering apparatus that can be fitted to bottles of any shape and size and that can be fitted on to water bottles, or baby bottles in any way or shape including clip on, rubber seal, magnet, screw on, etc.

It is another object of the present invention to provide a filtering apparatus having a place to hold liquid (such as water) as a reservoir until it is ready to filter and dispensed into another bottle.

In order to overcome the limitations here stated, the present invention provides a filtering apparatus for filtering liquid and dispensing into a bottle. The filtering apparatus includes an elongated housing having an interior for holding liquid. Here, the interior acts as a reservoir for holding the liquid until it is ready to be filtered and dispensed from the elongated housing. The elongated housing includes an opening at one end and a ceiling at another end. The opening encompasses projections extending towards the center of the elongated housing. The filtering apparatus includes a filter configured for insertion and removal from the elongated housing. The filter is made of carbon or charcoal, natural or artificial materials, woven or non-woven fibers, granular materials, foam, and membranes capable of filtering the liquid. In one example, the filter forms as a combination of filtration media including activated carbon fiber (ACF) material or ion exchange resin fiber (IERF) material, or a combination of both ACF and IERF materials.

The elongated housing receives the filter at the interior through the opening. The elongated housing receives a bottle at the opening and the projections hold the bottle at the opening while preventing further entry of the bottle into the interior of the elongated housing. Here, the projections act as bottle stoppers such that the bottle stops and/or secures at the projections and does not go beyond the projections.

In one implementation, the bottle includes a neck portion. The neck portion enters the opening of the elongated housing using one of a clip-on mechanism, a snap mechanism, threading, a magnet, or a hook and loop mechanism and connects the bottle to the filtering apparatus.

In operation, the interior of the elongated housing holds the liquid such as water. When the bottle is connected at the opening, the liquid flows down through the filter due to gravity. Flowing through the filter filters the liquid and makes the liquid free from contaminants and safe for drinking. The filtered water enters the bottle for subsequent use, storage or transport.

In one advantageous feature of the present invention, the filtering apparatus clips on to the bottle (such as a water bottle or baby bottle) in any way or shape including clip on, rubber seal, magnet, screw on, etc. The filtering apparatus can be used to filter all chemicals and ensure that the liquid is free from contaminants and safe for drinking. As specified above, the filtering apparatus can clip on to any bottle. For example, the filtering apparatus can connect to a baby bottle. Here, a user can fill water from any sink or water source in the interior (reservoir) of the filtering apparatus. The filtering apparatus filters the water and dispenses into the baby bottle. The user can detach the baby bottle from the filtering apparatus and use it on the go.

In another example, the filtering apparatus can be filled with sink water, or water from anywhere for use with a water bottle. The filtering apparatus filters the water and dispenses the filtered water into the water bottle. The water bottle can be used at home or carried anywhere.

In another example, the filtering apparatus can be clipped on to a water warmer. Here, the filtering apparatus can be filled with sink water, or water from anywhere. Subsequently, the filter can filter the water and dispense into the water warmer. The water warmer can be used to heat up water to the perfect temperature for use, say with the baby bottle, for example. In one example, the water warmer can include batteries for ease of operation and to allow it to be carried anywhere.

In another advantageous feature of the present invention, the filter is removably placed in the elongated housing. In one example, the filter can have a useful life of approximately 40-60 gallons or two months of use or depending on the efficiency and/or type of the filter. Thereafter, the filter can be removed and a new filter can be replaced in the elongated housing for subsequent use. This way, the filtering apparatus can be used for a prolonged period by replacing the filter from time to time.

In another advantageous feature of the present invention, the filtering apparatus filters the liquid and dispenses it into a bottle that is separate from the filtering apparatus. This ensures that the bottle of any shape and size can be fitted to the filtering apparatus to receive filtered liquid. The bottle can be used for drinking purposes or can be stored or transported. Further, the bottle having different connecting mechanisms such as a clip-on mechanism, a snap mechanism, threading, a magnet, or a hook and loop mechanism can be easily connected without having to change their structure.

In another advantageous feature of the present invention, the bottle includes a measuring indicator for indicating the quantity of the liquid received in the bottle.

In another advantageous feature of the present invention, the bottle includes a coil for heating or boiling the water received therein. This allows it to heat up water and further improve safety levels in consuming the water.

Features and advantages of the invention hereof will become more apparent in light of the following detailed description of selected embodiments, as illustrated in the accompanying FIGURES. As will be realized, the invention disclosed is capable of modifications in various respects, all without departing from the scope of the invention. Accordingly, the drawings and the description are to be regarded as illustrative in nature.

### BRIEF DESCRIPTION OF THE DRAWINGS

The present invention will now be described in detail with reference to the drawings, which are provided as illustrative examples of the invention as to enable those skilled in the art to practice the invention. It will be noted that throughout the appended drawings, like features are identified by like reference numerals. Notably, the FIGUREs and examples are not meant to limit the scope of the present invention to a single embodiment, but other embodiments are possible by way of interchange of some or all of the described or illustrated elements and, further, wherein:

FIG. 1 illustrates an exemplary environment of a filtering apparatus connecting a bottle, in accordance with one embodiment of the present invention;

FIG. 2 illustrates a perspective view of the filtering apparatus;

FIG. 3A illustrates the filtering apparatus aligned with a filter;

FIG. 3B shows the filter positioned in the filtering apparatus;

FIG. 4A illustrates the filtering apparatus aligned with the bottle;

FIG. 4B shows the filtering apparatus connected to the bottle;

FIG. 5A illustrates a filtering apparatus aligned with a baby bottle, in accordance with another embodiment of the present invention;

FIG. 5B shows the filtering apparatus connected to the baby bottle;

FIG. 6A illustrates a filtering apparatus aligned with a water warmer, in accordance with another embodiment of the present invention; and

FIG. 6B shows the filtering apparatus connected to the water warmer.

It will be noted that throughout the appended drawings, like features are identified by like reference numerals.

### DETAILED DESCRIPTION OF THE EMBODIMENTS

The detailed description set forth below in connection with the appended drawings is intended as a description of exemplary embodiments in which the presently disclosed invention may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed filtering apparatus. However, it will be apparent to those skilled in the art that the presently disclosed invention may be practiced without these specific details. In some instances, well-known structures and devices are shown in functional or conceptual diagram form in order to avoid obscuring the concepts of the presently disclosed filtering apparatus.

In the present specification, an embodiment showing a singular component should not be considered limiting. Rather, the invention preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known components referred to herein by way of illustration.

Although the present invention describes a filtering apparatus, it is to be further understood that numerous changes may arise in the details of the embodiments of the filtering apparatus. It is contemplated that all such changes and additional embodiments are within the spirit and true scope of this invention.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the invention and are not intended to limit the scope of the invention.

It should be understood that the present invention describes a filtering apparatus for filtering liquid and dispensing the filtered liquid into a bottle separate from the filtering apparatus. The filtering apparatus includes an elongated housing having an interior for holding liquid. The elongated housing includes an opening at one end and a ceiling at another end. The opening encompasses projections extending towards the center of the elongated housing. The filtering apparatus includes a filter configured for insertion and removal from the elongated housing. The elongated housing receives the filter at the interior through the opening. The elongated housing receives a bottle at the opening and the projections hold the bottle at the opening while preventing further entry of the bottle into the interior of the elongated housing. The interior holds liquid and allows the liquid to flow down through the filter. The filter filters the liquid as it flows through. The filtered water enters the bottle for subsequent use, storage or transport.

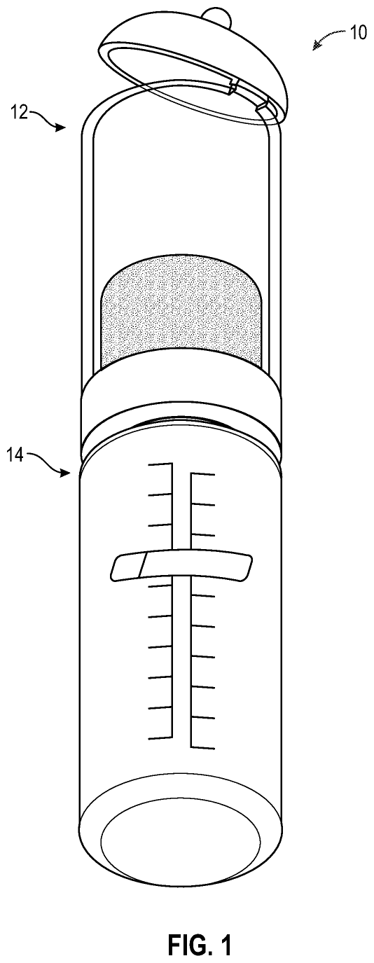

Various features and embodiments of a filtering apparatus for filtering liquid and dispensing the liquid into a bottle are explained in conjunction with the description of FIGS. 1 to 6B.

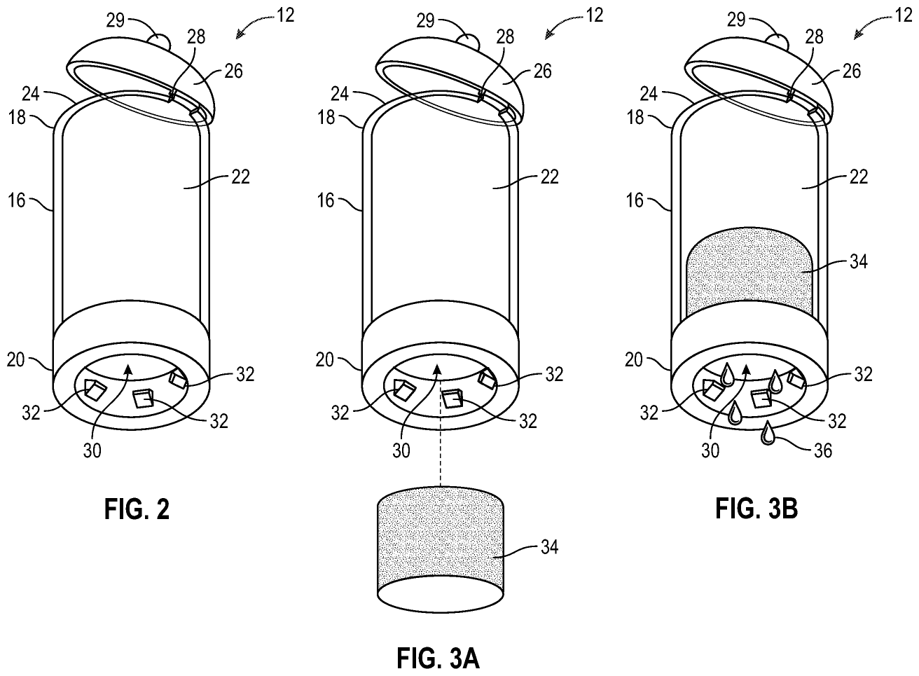

In one embodiment, the present invention discloses a filtering apparatus for filtering liquid such as water. FIG. 1 shows an exemplary environment 10 of the filtering apparatus 12 connecting to a bottle or container 14. FIG. 2 shows a perspective view of the filtering apparatus 12, in accordance with one embodiment of the present invention. The filtering apparatus 12 includes an elongated housing 16. The elongated housing 16 provides a material made of metal such as stainless steel, aluminium, or high quality plastics, for example including, but not limited to, poly(etherether ketone), polyethylene, polypropylene, polystyrene, polyvinyl chloride, polytetrafluoroethylene, or other thermoplastics and polymers. In one example, the elongated housing 16 provides a material made of a non-toxic plastic composition such as High Density Polyethylene (HDP), Low Density Polyethylene (LDP), or Polypropylene (PP) to prevent leaching of toxic plastic by-products into the liquid contained in the elongated housing 16, and thereby avoiding hazardous consumption of plastic toxins. In the present description, the terminologies liquid and water may be used interchangeably.

The elongated housing 16 presents a first end 18 and a second end 20. The first end 18 indicates the top end and the second end 20 indicates the bottom end. The elongated housing 16 encompasses an interior 22 for holding liquid 36 such as water. At the first end 18, the elongated housing 16 includes a ceiling 24. It should be understood that when the second end 20 faces the ground, the ceiling 24 positions at the top and acts as a roof. Further, when the first end 18 is made to face the ground (i.e., when the elongated housing 16 is tilted from the position shown in FIG. 2) the ceiling 24 acts as a base for the elongated housing 16 and holds liquid such as water in the interior 22. Here, the interior 22 acts as a reservoir for holding the liquid.

The elongated housing 16 encompasses a cover 26 at the ceiling 24. The cover 26 mounts to the housing 16 via hinges 28 and opens or closes depending on the need. The cover 26 encompasses a hook-like structure 29. The hook-like structure 29 allows the cover to hang or connect the elongated housing 16 to a structure when not in use. Alternatively, the hook-like structure 29 connects to devices e.g., keychains or other devices for easy storage and transport.

At the second end 20, the elongated housing 16 encompasses an opening 30. At the inner portion, the opening 30 presents projections 32 that extend towards the center of the elongated housing 16. The projections 32 act as stoppers for a bottle when the elongated housing 16 receives the bottle at the opening 30. Here, the projections 32 prevent the bottle from going further into the opening 30 of the elongated housing 16. In accordance with the present invention, the projections 32 come in a variety of configurations including, but not limited to, a single ridge or O-ring extending over the entire opening. The projections 32 can receive bottles having a variety of connecting mechanisms, such as clip-on or snap mechanism, threading (or screw), magnet, rubber seal, etc.

In accordance with the present invention, the filtering apparatus 12 includes a filter 34. The filter 34 comes in a variety of shapes and sizes depending on the need. The filter 34 provides a material made of carbon or charcoal, natural or artificial materials, woven or non-woven fibers, granular materials, foam, one or more membranes, or any other material or construction for filtering a liquid. In one example, the filter 34 is formed of a unitary member having a central opening so that it can be easily inserted and removed from the elongated housing 16. In another example, the filter 34 provides a material made of particulate or granular material or layered materials or of other constructions. Here, the filter 34 can be enclosed within a filter cartridge or other housing. In one example, the filter 34 is formed as a combination of filtration media that includes activated carbon fiber (ACF) material or ion exchange resin fiber (IERF) material, or a combination of both ACF and IERF materials, which can take the form of a mixture of granular activated carbon (GAC) and one or more ion exchange resins (IER). Alternatively, the GAC and IER are not mixed together but, instead, form respective layers in the filter 34, where the GAC layer is the top layer, and the IER layer is the bottom layer. In one example, the filter 34 is biodegradable or at least eco-friendly. In one example, the filter 34 includes activated carbon with an outer covering made of a porous paper.

In the current embodiment, the elongated housing 16 receives the filter 34 via an opening 30 at the second end 20. A person skilled in the art understands that a filter 34 is easily insertable and removable from the elongated housing 16 through the opening 30. FIG. 3A shows the features of the filter 34 aligned with the elongated housing 16. As can be seen, the filter 34 aligns with the opening 30 of the elongated housing 16. A user of filtering apparatus 12 places/pushes/positions the filter 34 into the interior 22 of the elongated housing 16. Upon placing, the filter 34 snugly and securely sits at the bottom of the interior 22. FIG. 3B shows the features of the filter 34 snugly and securely placed at the bottom of the interior 22, in accordance with one embodiment of the present invention.

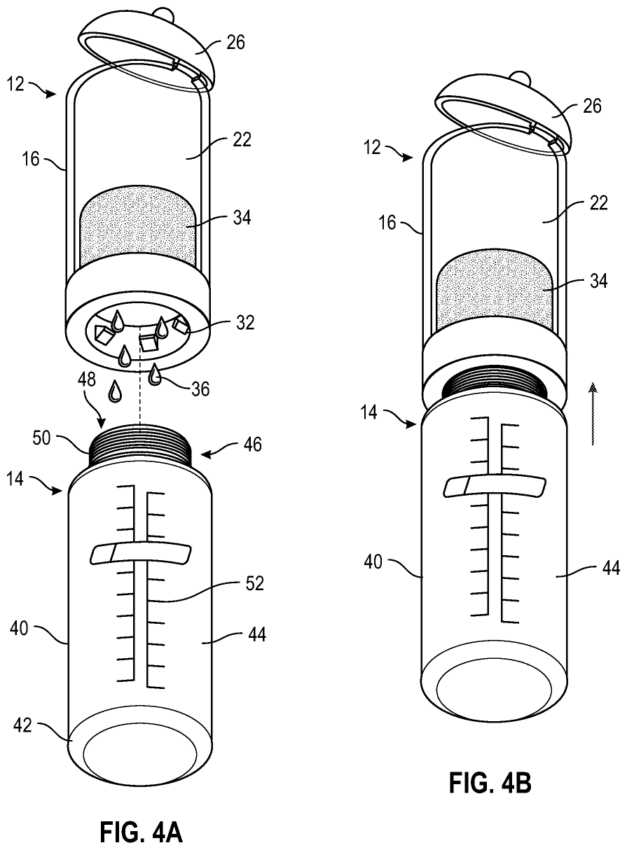

In one implementation, the user of the filtering apparatus 12 positions the ceiling 24 to face the ground. Upon position, the user fills liquid 36 such as water into the interior 22 (reservoir) of the elongated housing 16. The user can fill water from a sink or any other water source. Subsequently, the user places the filter 34 via the opening 30 into the interior 22. After placing the filter 34, the user tilts the elongated housing 16 such that the liquid 36 flows down from the interior 22 through the filter 34 and comes out of the elongated housing 16 by way of gravity. FIG. 4A shows the feature of liquid 36 flowing down the elongated housing 16 from the interior 22 through the filter 34 and the opening 32. As liquid 34 flows through, the filter 34 filters the liquid 36 and ensures it is free from contaminants and safe for drinking.

In accordance with one embodiment of the present invention, the filtering apparatus 12 connects to a bottle 14 for storing liquid 36 filtered by the filter 34. FIG. 4A shows the filtering apparatus 12 aligning with the bottle 14 for dispensing liquid 36 into the bottle 14. Here the bottle 14 includes, but is not limited to, a baby bottle, water bottle, water warmer or any other container that can store liquid. In one implementation, the bottle 14 includes a body 40. The body 40 provides a material made of metal, high quality plastic or any other suitable material. The body 40 includes a transparent or semi-transparent or opaque material. The body 40 provides a material made of a non-toxic plastic composition such as High Density Polyethylene (HDP), Low Density Polyethylene (LDP), or Polypropylene (PP) to prevent leaching of toxic plastic by-products into the water contained in the elongated housing 16, and thereby avoiding hazardous consumption of plastic toxins.

The body 40 presents a base 42. The body 40 encompasses a liquid storing area 44. The body 40 includes a neck portion 46 with an orifice 48 at the top. The neck portion 46 includes threading 50 at its outer side. In one example, the body 40 includes a measuring indicator 52 at its outer side. The measuring indicator 52 presents an indication to quantity or amount of liquid 36 stored in the liquid storing area 44.

In accordance with one embodiment, the bottle 14 connects to a filtering apparatus 12 for receiving filtered liquid 36. In order to connect, the bottle 14 aligns with the filtering apparatus 12. Here, the neck portion 46 enters the opening 30 of the filtering apparatus 12. Projections 32 hold the neck portion 46 in place such that the bottle 14 secures to the filtering apparatus 12. FIG. 4B shows the feature of the bottle 14 connecting to the filtering apparatus 12, in accordance with one embodiment of the present invention. Upon connecting, liquid 36 from the interior 22 flows down through the filter 34 and into the liquid storing area 44 thereby filling filtered liquid 36 in to the liquid storing area 44. After filling the required amount/quantity of liquid 36, the user pulls out the bottle 14 from the filtering apparatus 12. The user uses the bottle 14 containing filtered liquid 36 for drinking or any other use depending on the need.

The filter 34 can be removed to clean the interior 22 of the elongated housing 16 and reinserted into the interior 22 upon cleaning. In one example, the filter 34 has a useful life of approximately 40-60 gallons or two months of use or depending on the efficiency and/or type of filter 34. Thereafter, the filter 34 is removed and a new filter 34 is replaced in the interior 22 of the elongated housing 16 for subsequent use. This way, the filtering apparatus 12 can be used for a prolonged period by replacing the filter 34 from time to time.

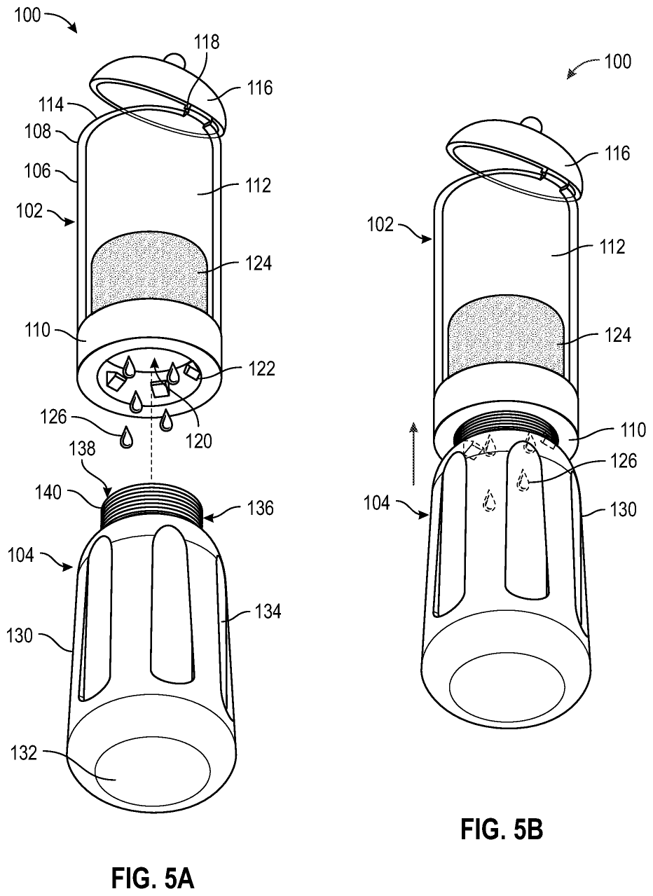

A person skilled in the art understands that the filtering apparatus 12 can be used to filter liquid 34 and dispense filtered liquid 34 into a variety of bottles having varied connecting mechanisms. FIGS. 5A and 5B show an environment 100 of the filtering apparatus 102 connecting to a baby bottle 104, in accordance with another embodiment of the present invention. Specifically, FIG. 5A shows the feature of the filtering apparatus 102 aligned with a baby bottle 104. FIG. 5B shows the feature of the filtering apparatus 102 connecting to the baby bottle 104. Similar to the filtering apparatus 12, the filtering apparatus 102 includes an elongated housing 106. The elongated housing 106 presents a first end 108 and a second end 110. The first end 108 indicates the top end and the second end 100 indicates the bottom end. The elongated housing 106 encompasses an interior 112 for holding liquid 126 such as water. At the first end 108, the elongated housing 106 includes a ceiling 114.

The elongated housing 106 encompasses a cover 116 at the ceiling 114. The cover 116 mounts to the housing 106 via hinges 118 and opens or closes depending on the need. At the second end 110, the elongated housing 106 encompasses an opening 120. At the inner portion, the opening 120 presents projections 122 that extend towards the center of the elongated housing 106. Projections 122 act as stoppers when the elongated housing 106 receives a baby bottle 104. Here, projections 122 prevent the bottle from going further into the opening 120 of the elongated housing 106. In accordance with the present invention, projections 122 come in a variety of configurations including, but not limited to, a single ridge extending over the entire opening. Projections 122 receive bottles having a variety of connecting mechanisms such as a clip-on or snap mechanism, threading, a magnet, a rubber seal, etc. In accordance with the present invention, the filtering apparatus 102 receives a filter 124 via an opening 120 at the second end 110. As can be seen from FIG. 5A, the filter 124 snugly and securely sits at the bottom of the interior 112.

The baby bottle 104 includes a body 130. The body 130 presents a base 132. The body 130 encompasses a liquid storing area 134. The body 130 includes a neck portion 136 with an orifice 138 at the top. The neck portion 136 includes threading 140 at its outer side.

In accordance with one embodiment, the baby bottle 104 connects to a filtering apparatus 102 for receiving filtered liquid 126. In order to connect, the baby bottle 104 aligns with the filtering apparatus 102. Here, the neck portion 136 enters the opening 120 of the filtering apparatus 102. Projections 122 hold the neck portion 136 in place such that the baby bottle 104 secures to the filtering apparatus 102. FIG. 5B shows the feature of the baby bottle 104 connecting to the filtering apparatus 102, in accordance with one embodiment of the present invention. Upon connecting, liquid 126 from the interior 112 flows down through the filter 124 and into the liquid storing area 134 thereby filling the filtered liquid 126 in to the liquid storing area 134. After filling the required amount/quantity of liquid 126, the user pulls out the baby bottle 104 from the filtering apparatus 102. The user uses the baby bottle 104 containing filtered liquid 126 for drinking or any other use depending on the need.

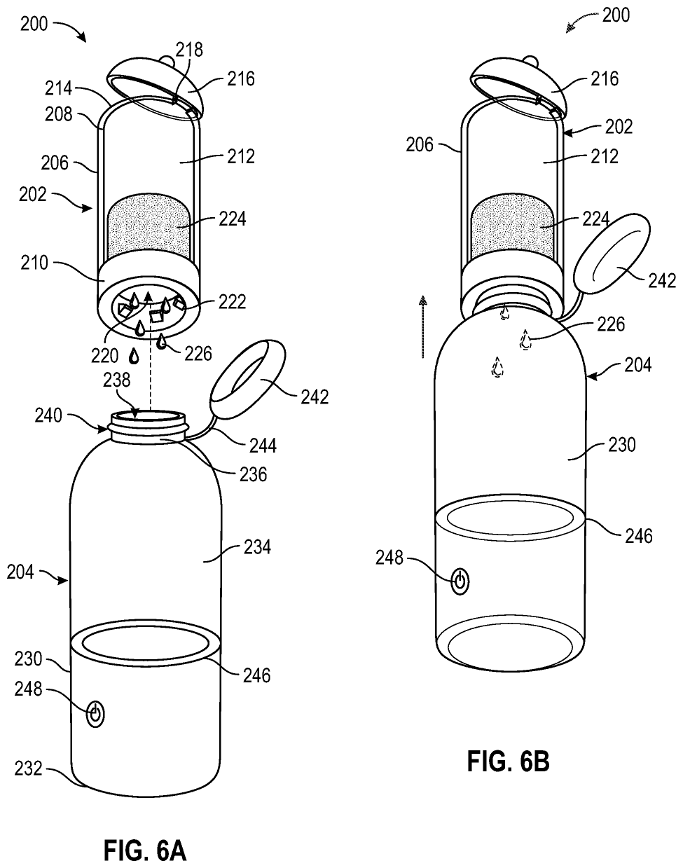

FIGS. 6A and 6B show an environment 200 of the filtering apparatus 202 connecting to a water warmer 204, in accordance with another embodiment of the present invention. Specifically, FIG. 6A shows the feature of the filtering apparatus 202 aligned with the water warmer 204. FIG. 6B shows the feature of the filtering apparatus 202 connecting to the water warmer 204. Similarly to the filtering apparatus 12, the filtering apparatus 202 includes an elongated housing 206. The elongated housing 206 presents a first end 208 and a second end 200. The first end 208 indicates the top end and the second end 210 indicates the bottom end. The elongated housing 206 encompasses an interior 212 for holding liquid 226 such as water. At the first end 208, the elongated housing 206 includes a ceiling 214.

The elongated housing 206 encompasses a cover 216 at the ceiling 214. The cover 216 mounts to the housing 206 via hinges 218 and opens or closes depending on the need. At the second end 210, the elongated housing 206 encompasses an opening 220. At the inner portion, the opening 220 presents projections 222 that extend towards the center of the elongated housing 206. Projections 222 act as stoppers when the elongated housing 206 receives the water warmer 204. Here, projections 222 prevent the water warmer 204 from going further into the opening 220 of the elongated housing 206. In accordance with the present invention, projections 222 come in a variety of configurations including, but not limited to, a single ridge extending over the entire opening. Projections 222 receive bottles having a variety of connecting mechanisms such as a clip-on or snap mechanism, threading, a magnet, rubber seal, etc. In accordance with the present invention, the filtering apparatus 202 receives the filter 224 via an opening 220 at the second end 210. As can be seen from FIG. 6A, the filter 224 snugly and securely sits at the bottom of the interior 212.

The water warmer 204 includes a body 230. The body 230 presents a base 232. The body 230 encompasses a liquid storing area 234. The body 230 includes a neck portion 236 with an orifice 238 at the top. The neck portion 236 includes a ridge or O-ring 240 at its outer side. The body 230 further includes a cap 242 for covering the orifice 238. The cap 242 connects to the body 230 via a connector 244. In one implementation, the body 230 includes a coil 246 at its inner wall. The coil 246 helps to boil or heat up liquid 236 stored in the liquid storing area 234. In one example, the body 230 includes a button 248 at its outer surface for powering the coil ON/OFF 246.

In accordance with one embodiment, the water warmer 204 connects to a filtering apparatus 202 for receiving filtered liquid 226. In order to connect, the water warmer 204 aligns with the filtering apparatus 202. Here, the neck portion 236 enters the opening 220 of the filtering apparatus 202. Projections 222 hold the neck portion 236 in place such that the water warmer 204 secures to the filtering apparatus 202. Specifically, the O-ring 240 connects to projections 222 and secures the water warmer 204 to the filtering apparatus 202. FIG. 6B shows the feature of the water warmer 204 connecting to the filtering apparatus 202, in accordance with one embodiment of the present invention. Upon connecting, liquid 226 from the interior 212 flows down through the filter 224 and into the liquid storing area 234 thereby filling filtered liquid 226 in to the liquid storing area 234. After filling the required amount/quantity of liquid 226, the user pulls out the water warmer 204 from the filtering apparatus 202. The user uses the water warmer 204 containing filtered liquid 226 for drinking or any other purpose depending on the need. In accordance with one embodiment of the present invention, the user powers ON button 248 and heats up the liquid 226 stored in the liquid storing area 234. This helps to have filtered water and hot water in a short period of time.

Based on the above, it is evident that the presently disclosed filtering apparatus helps to filter liquid and dispense the filtered liquid into a bottle separate from the filtering apparatus for subsequent use, storage or transport.

The presently disclosed filtering apparatus provides several advantages over known bottles having filters. For example, the presently disclosed filtering apparatus clips on to the bottle (such as a water bottle, baby bottle, water warmer or any other container) in any way or shape including clip on, rubber seal, magnet, screw on, etc. This allows the filtering apparatus to be used as a universal apparatus to be fitted with any device for filtering water at any time or anywhere. The filtering apparatus can be used to filter all chemicals and ensure that the liquid is free from contaminants and safe for drinking. The filtering apparatus can be carried as a separate device in order to filter water on the go with or without the use of a bottle. The user can simply fill water in the interior or reservoir, receive the filtered water due to gravity and drink directly from the filtering apparatus.

A person skilled in the art appreciates that the filtering apparatus may come in a variety of shapes and sizes depending on the need and comfort of the user. Further, different materials in addition to or instead of materials described herein may also be used and such implementations may be construed to be within the scope of the present invention. Further, many changes in the design and placement of components may take place without deviating from the scope of the presently disclosed filtering apparatus.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

What is claimed is:

1. A filtering apparatus for filtering liquid and dispensing the filtered liquid into a bottle separate from said filtering apparatus, said filtering apparatus comprising:
an elongated housing having an interior for holding liquid, wherein said elongated housing comprises an opening at one end and a ceiling at another end, and wherein said opening comprises projections extending towards center of said elongated housing; and
a filter configured for insertion and removal from said elongated housing, wherein said elongated housing receives said filter at said interior through said opening,
wherein said elongated housing receives a bottle at said opening and said projections hold said bottle at said opening while preventing further entry of said bottle into said interior of said elongated housing, and
wherein said interior holds liquid and allows the liquid to flow down through said filter due to gravity, wherein said filter filters the liquid as it flows through, and wherein the filtered water enters said bottle for subsequent use.

2. The filtering apparatus of claim 1, wherein said elongated housing is made of a metal or plastic.

3. The filtering apparatus of claim 1, wherein said filter is made of carbon or charcoal, natural or artificial materials, woven or non-woven fibers, granular materials, foam, and membranes capable of filtering the liquid.

4. The filtering apparatus of claim 1, wherein said filter forms as a combination of filtration media including activated carbon fiber (ACF) material or ion exchange resin fiber (IERF) material, or a combination of both ACF and IERF materials.

5. The filtering apparatus of claim 1, wherein said elongated housing comprises a cover at said ceiling.

6. The filtering apparatus of claim 1, wherein said cover comprises a hook-like structure for connecting said filtering apparatus to a structure.

7. The filtering apparatus of claim 1, wherein said bottle comprises a liquid storing area for receiving and storing the filtered liquid.

8. The filtering apparatus of claim 7, wherein said bottle comprises a measuring indicator for indicating the quantity of the liquid received in said liquid storing area.

9. The filtering apparatus of claim 1, wherein said bottle comprises a neck portion, and wherein said neck portion enters said opening of said elongated housing using one of a clip-on mechanism, a snap mechanism, threading, a magnet, and a hook and loop mechanism.

10. The filtering apparatus of claim 1, wherein said bottle comprises a neck portion, and wherein said neck portion enters said opening of said elongated housing.

11. The filtering apparatus of claim 10, wherein said neck portion comprises a threading at its outer side, wherein said threading connects to said projections and allows to connect said bottle to said elongated housing.

12. The filtering apparatus of claim 10, wherein said neck portion comprises an O-ring, wherein said O-ring connects to said projections and allows to connect said bottle to said elongated housing.

13. The filtering apparatus of claim 1, wherein said bottle comprises a coil for heating up the liquid received in said bottle.

14. A method of providing a filtering apparatus for filtering liquid and dispensing the filtered liquid into a bottle separate from said filtering apparatus, said method comprising steps of:
providing an elongated housing having an interior for holding liquid, said elongated housing comprising an opening at one end and a ceiling at another end, said opening comprising projections extending towards the center of said elongated housing;
providing a filter configured for insertion and removal from said elongated housing;
receiving said filter at said interior through said opening of said elongated housing;
receiving a bottle at said opening such that said projections hold said bottle at said opening while preventing further entry of said bottle into said interior of said elongated housing;
holding liquid at said interior;
allowing the liquid to flow down through said filter due to gravity;
filtering the liquid as the liquid flows down through said filter; and
filling said bottle with the filtered liquid for subsequent use.

15. The method of claim 14, further comprises providing a liquid storing area in said bottle for receiving and storing the filtered liquid.

16. The method of claim 15, further comprises providing a measuring indicator at the outer side of said bottle for indicating the quantity of the liquid received in said liquid storing area.

17. The method of claim 14, further comprises providing a neck portion at said bottle, said neck portion configured for entering said opening of said elongated housing using one of a clip-on mechanism, a snap mechanism, threading, a magnet, or a hook and loop mechanism.

18. The method of claim 14, further comprises providing a neck portion at said bottle, said neck portion comprising a threading, said threading connecting said projections in order to connect said bottle to said elongated housing.

19. The method of claim 14, further comprises providing a neck portion at said bottle, said neck portion comprising an O-ring, said O-ring connecting said projections in order to connect said bottle to said elongated housing.

20. The method of claim 14, further comprises providing a coil at said bottle for heating up the liquid received in said bottle.
